(19) United States
(12) Patent Application Publication
(10) Pub. No.: US 2019/0116376 A1
(43) Pub. Date: Apr. 18, 2019

(54) MOTION VECTOR PREDICTORS USING AFFINE MOTION MODEL IN VIDEO CODING

(71) Applicant: QUALCOMM Incorporated, San Diego, CA (US)

(72) Inventors: Yi-Wen CHEN, San Diego, CA (US); Yu-Chen SUN, Bellevue, CA (US); Wei-Jung CHIEN, San Diego, CA (US); Hsiao-Chiang CHUANG, San Diego, CA (US); Marta KARCZEWICZ, San Diego, CA (US)

(21) Appl. No.: 16/158,033

(22) Filed: Oct. 11, 2018

Related U.S. Application Data
(60) Provisional application No. 62/571,609, filed on Oct. 12, 2017.

(51) Int. Cl. H04N 19/513; H04N 19/176

(52) U.S. Cl. CPC H04N 19/521; H04N 19/176

(57) ABSTRACT

Motion compensated prediction using affine motion models can be used to improve coding efficiency. In a practical encoder/decoder, a line buffer is used to store associated data for neighboring blocks. Embodiments of affine model based motion compensated prediction include methods and systems of determining motion vectors for control points that are aware of line buffer storage limitations.

### CLAIM OF PRIORITY UNDER 35 U.S.C. § 119

The present Application for Patent claims priority to U.S. Provisional Application No. 62/571,609 entitled “GENERATION OF MOTION VECTOR PREDICTORS USING AFFINE MOTION MODEL IN VIDEO CODING,” filed Oct. 12, 2017 and assigned to the assignee hereof and hereby expressly incorporated by reference herein.

### BACKGROUND

### Field

This application is directed to the field of video coding, e.g., encoding and decoding of video bitstreams.

### Background

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multi-view Video Coding (MVC) extensions.

In addition, High Efficiency Video Coding (HEVC) or ITU-T H.265, including its range extension, multiview extension (MV-HEVC) and scalable extension (SHVC), has been developed by the Joint Collaboration Team on Video Coding (JCT-VC) as well as Joint Collaboration Team on 3D Video Coding Extension Development (JCT-3V) of ITU-T Video Coding Experts Group (VCEG) and ISO/IEC Motion Picture Experts Group (MPEG). The latest HEVC draft specification, and referred to as HEVC WD hereinafter, is available from http://phenix.int-evry.fr/jct/doc_end_user/documents/14_Vienna/wg11/JCTVC-N1003-v1.zip

ITU-T VCEG (Q6/16) and ISO/IEC MPEG (JTC 1/SC 29/WG 11) recently studied the potential need for standardization of future video coding technology with a compression capability that significantly exceeds that of the current HEVC standard (including its current extensions and near-term extensions for screen content coding and high-dynamic-range coding). The groups are working together on this exploration activity in a joint collaboration effort known as the Joint Video Exploration Team (JVET) to evaluate compression technology designs proposed by their experts in this area. The JVET first met during 19-21 Oct. 2015. This work has matured into a collaborative effort under way by the JVET group to design a next generation video codec, based on HEVC and the JVET exploration. The output of the work, a Joint Exploration Model (JEM) is publicly available. For example, JEM, version 7, may be downloaded from cites such as https://jvet.hhi.fraunhofer.de/svn/svn_HMJEMSoftware/tags/HM-16.6-JEM-73.0/. An algorithm description of Joint Exploration Test Model 7 (JEM7) referred to herein are disclosed in document JVET-G1001 (J. Chen, E. Alshina, G. J. Sullivan, J.-R. Ohm, J. Boyce, “Algorithm Description of Joint Exploration Test Model 7”, JVET-G1001, July 2017).

As part of that effort, new tools have been proposed to improve coding gain such as using affine motion models for inter-prediction. A need exists for improvements to such techniques.

### SUMMARY

Motion compensated prediction using affine motion models can be used to improve coding efficiency. In a practical encoder/decoder, a line buffer is used to store associated data for neighboring blocks. Embodiments of affine model based motion compensated prediction include methods and systems of determining motion vectors for control points that are aware of line buffer storage limitations. For example, embodiments include ways of generating alternative control points or alternative motion vectors when unavailable due to line buffer considerations.

One embodiment includes a method of encoding or decoding video data using affine motion predictors. The method includes determining motion vectors for at least three affine control points from neighboring blocks of a current video block, the neighboring blocks including a top neighboring block. The method of further includes determining for a top neighboring affine block that motion vectors of one or more control points of an affine motion model of the neighboring affine block is unavailable from a line buffer. Based on the determination that the one or more control points are unavailable, the method includes determining one or more other motion vectors based on motion vectors the neighboring blocks that are stored in the line buffer and generating a motion vector predictor using the determined other motion vectors stored in the line buffer. The method further includes coding (encoding or decoding) the video block based the generated motion vector predictor.

Another embodiment includes an apparatus for encoding or decoding video data using affine motion predictors. The apparatus includes a memory configured to store a line buffer comprising motion vectors of neighboring blocks of a current video block and a processor. The processor is configured to determine motion vectors for at least three affine control points from neighboring blocks of the current video block, the neighboring blocks comprising a top neighboring block. The processor is further configured to determine for a top neighboring affine block that motion vectors of one or more control points of an affine motion model of the neighboring affine block is unavailable from a line buffer. Based on the determination that the one or more control points are unavailable, the processor is further configured to determine one or more other motion vectors based on motion vectors the neighboring blocks that are stored in the line buffer and generate a motion vector predictor using the determined other motion vectors stored in the line buffer. The processor is further configured to code (encode or decode) the video block based the generated motion vector predictor.

Another embodiment includes an apparatus for encoding or decoding video data using affine motion predictors. The apparatus includes means for storing a line buffer comprising motion vectors of neighboring blocks of a current video block. The apparatus further includes means for determining motion vectors for at least three affine control points from neighboring blocks of the current video block, the neighboring blocks comprising a top neighboring block. The determining means is further configured to determine for a top neighboring affine block that motion vectors of one or more control points of an affine motion model of the neighboring affine block is unavailable from a line buffer. Based on the determination that the one or more control points are unavailable, the determining means is further configured to determine one or more other motion vectors based on motion vectors the neighboring blocks that are stored in the line buffer and generate a motion vector predictor using the determined other motion vectors stored in the line buffer. The apparatus further includes means for coding (encoding or decoding) the video block based the generated motion vector predictor.

### BRIEF DESCRIPTION OF THE DRAWINGS

FIG. 1 is a block diagram illustrating an example video encoding and decoding system that may utilize the techniques described in this disclosure.

FIG. 2 is a block diagram illustrating an example video encoder that may implement the techniques described in this disclosure.

FIG. 3 is a block diagram illustrating an example video decoder that may implement the techniques described in this disclosure.

FIGS. 4a and 4b illustrate examples of two prediction units along with neighboring blocks at positions labeled according to a derivation order for a motion vector candidate list.

FIG. 5 is a diagram illustrating two example prediction units with respect to temporal motion vector predictor (TMVP) candidate generation.

FIG. 6 is a diagram illustrating the relationship between a motion vector and a TMVP candidate.

FIG. 7 is a diagram illustrating a current block 702 encoded using one example of an affine model.

FIG. 8 is a diagram illustrating a current block encoded as an affine block using another affine model.

FIG. 9 is a diagram illustrating a motion compensated prediction (MCP) motion vector (MV) field.

FIG. 10 is a diagram illustrating a stored MV field.

FIG. 11a illustrates an example motion vector predictor for an affine inter prediction mode.

FIG. 11b is a table illustrating an example affine motion vector predictor set for the example of FIG. 11a.

FIG. 12 is a block diagram illustrating a current block 1202 and neighboring candidate blocks.

FIG. 13 is a block diagram illustrating a current block and an affine neighboring block.

FIG. 14a illustrates another example motion vector predictor for an affine inter prediction mode.

FIG. 14b is a table illustrating an example affine motion vector predictor set for the example of FIG. 14a.

FIG. 15 is diagram illustrating a line buffer for a coding tree unit of a current picture.

FIGS. 16 and 17 are diagrams illustrating a current block and a line buffer along with a neighboring affine block and corresponding control points with respect to one embodiment.

FIGS. 18 and 19 are diagrams illustrating a current block and a line buffer along with a neighboring affine block and corresponding control points with respect to another embodiment.

FIG. 20 is a diagram illustrating a current block and a line buffer relative to another embodiment that includes modified motion vector prediction generation.

FIG. 21 is a diagram illustrating a current block and a line buffer relative to another embodiment that includes modified motion vector prediction generation based on selecting a specified number of neighboring control points.

FIG. 22 is a diagram illustrating a number of motion compensated prediction (MCP) motion vector (MV) fields with respect to another embodiment.

FIG. 23 is a diagram illustrating a motion compensated prediction (MCP) motion vector (MV) field relative to another embodiment.

FIG. 24 is diagram illustrating an enlarged line buffer.

### DETAILED DESCRIPTION

In many codecs, only a translational motion model is applied for motion compensation prediction (MCP). However, other kinds of motions such as zoom in/out, rotation, perspective motions, and similar such irregular motions may not be well predicted using only the translation motion. In such examples, using affine transform motion compensation prediction can improve the coding efficiency. As described in detail below, representations of affine motion models may use control points and motion vectors for those control points to define the affine motion model to which a transform is applied to generate an inter-prediction block from a reference block. The inter-prediction techniques such as motion vector prediction can be applied to those motion vectors. As described further below, to derive affine motion predictors for an affine block (including affine inter mode and affine merge mode), the motion vectors of the top-left, top-right and bottom-left corner (for example, 4×4) blocks may be used to generate the affine motion vector predictors. However, when the neighboring affine blocks are located at the upper CTU row, the motion information of the top-left, top-right corner blocks may not be stored in the motion data line buffer. Corresponding situations arise on when the neighboring affine blocks are located on the right CTU column. Embodiments include ways of performing motion vector prediction generation that are aligned with the motion vector line buffer design.

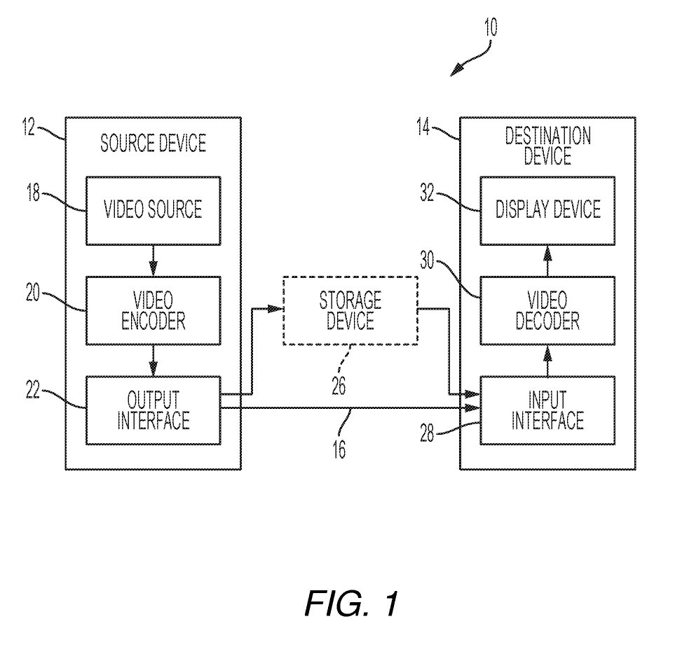

As context to discuss examples and embodiments in further details, FIG. 1 is a block diagram illustrating an example video encoding and decoding system 10 that may utilize the techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In another example, encoded data may be output from output interface 22 to a storage device 26. Similarly, encoded data may be accessed from storage device 26 by input interface. Storage device 26 may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, storage device 26 may correspond to a file server or another intermediate storage device that may hold the encoded video generated by source device 12. Destination device 14 may access stored video data from storage device 26 via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from storage device 26 may be a streaming transmission, a download transmission, or a combination of both.

The techniques of this disclosure are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called smartphones, camera phones or video phones. However, the techniques described in this disclosure may be applicable to video coding in general, and may be applied to wireless and/or wired applications.

The captured, pre-captured, or computer-generated video may be encoded by video encoder 20. The encoded video data may be transmitted directly to destination device 14 via output interface 22 of source device 12. The encoded video data may also (or alternatively) be stored onto storage device 26 for later access by destination device 14 or other devices, for decoding and/or playback.

Destination device 14 includes an input interface 28, a video decoder 30, and a display device 32. In some cases, input interface 28 may include a receiver and/or a modem. Input interface 28 of destination device 14 receives the encoded video data over link 16. The encoded video data communicated over link 16, or provided on storage device 26, may include a variety of syntax elements generated by video encoder 20 for use by a video decoder, such as video decoder 30, in decoding the video data. Such syntax elements may be included with the encoded video data transmitted on a communication medium, stored on a storage medium, or stored a file server.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

Video encoder 20 and video decoder 30 may operate according to newer v video compression standards that operate similarly to the recently finalized High Efficiency Video Coding (HEVC) standard. In particular, techniques of this disclosure may utilize HEVC terminology for ease of explanation. It should not be assumed, however, that the techniques of this disclosure are limited to HEVC, and in fact, it is explicitly contemplated that the techniques of this disclosure may be implemented in successor standards to HEVC and its extensions.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, in some examples, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device.

In HEVC and other video coding specifications, a video sequence typically includes a series of pictures. Pictures may also be referred to as “frames.” In one example approach, a picture may include three sample arrays, denoted S_{L}, S_{Cb}, and S_{Cr}. In such an example approach, S_{L} is a two-dimensional array (i.e., a block) of luma samples. Scb is a two-dimensional array of Cb chrominance samples. Scr is a two-dimensional array of Cr chrominance samples. Chrominance samples may also be referred to herein as “chroma” samples. In other instances, a picture may be monochrome and may only include an array of luma samples.

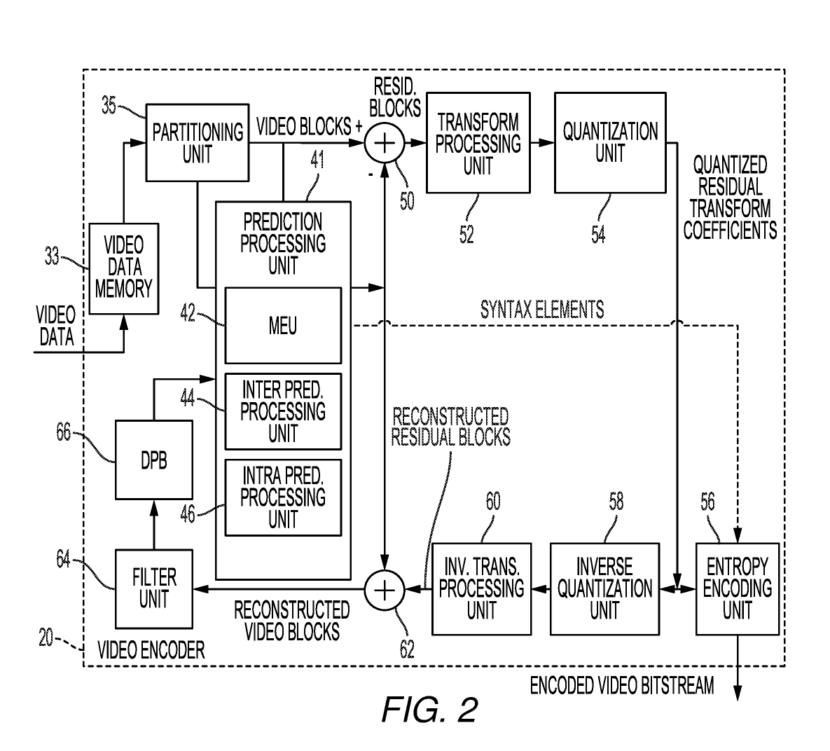

FIG. 2 is a block diagram illustrating an example video encoder 20 that may implement the techniques described in this disclosure. Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

In the example of FIG. 2, video encoder 20 includes a video data memory 33, partitioning unit 35, prediction processing unit 41, summer 50, transform processing unit 52, quantization unit 54, entropy encoding unit 56. Prediction processing unit 41 includes motion estimation unit (MEU) 42, motion compensation unit (MCU) 44, and intra prediction unit 46. For video block reconstruction, video encoder 20 also includes inverse quantization unit 58, inverse transform processing unit 60, summer 62, filter unit 64, and decoded picture buffer (DPB) 66.

As shown in FIG. 2, video encoder 20 receives video data and stores the received video data in video data memory 33. Video data memory 33 may store video data to be encoded by the components of video encoder 20. The video data stored in video data memory 33 may be obtained, for example, from video source 18. DPB 66 may be a reference picture memory that stores reference video data for use in encoding video data by video encoder 20, e.g., in intra- or inter-coding modes. Video data memory 33 and DPB 66 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 33 and DPB 66 may be provided by the same memory device or separate memory devices. In various examples, video data memory 33 may be on-chip with other components of video encoder 20, or off-chip relative to those components.

Partitioning unit 35 retrieves the video data from video data memory 33 and partitions the video data into video blocks. This partitioning may also include partitioning into slices, tiles, or other larger units, as wells as video block partitioning, e.g., according to a quadtree structure of LCUs and CUs. Video encoder 20 generally illustrates the components that encode video blocks within a video slice to be encoded. The slice may be divided into multiple video blocks (and possibly into sets of video blocks referred to as tiles). Prediction processing unit 41 may select one of a plurality of possible coding modes, such as one of a plurality of intra coding modes or one of a plurality of inter coding modes, for the current video block based on error results (e.g., coding rate and the level of distortion). Prediction processing unit 41 may provide the resulting intra- or inter-coded block to summer 50 to generate residual block data and to summer 62 to reconstruct the encoded block for use as a reference picture.

Intra prediction unit 46 within prediction processing unit 41 may perform intra-predictive coding of the current video block relative to one or more neighboring blocks in the same frame or slice as the current block to be coded to provide spatial compression. Motion estimation unit 42 and motion compensation unit 44 within prediction processing unit 41 perform inter-predictive coding of the current video block relative to one or more predictive blocks in one or more reference pictures to provide temporal compression.

Motion estimation unit 42 may be configured to determine the inter-prediction mode for a video slice according to a predetermined pattern for a video sequence. The predetermined pattern may designate video slices in the sequence as P slices or B slices. Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference picture.

A predictive block is a block that is found to closely match the PU of the video block to be coded in terms of pixel difference, which may be determined by sum of absolute difference (SAD), sum of square difference (SSD), or other difference metrics. In some examples, video encoder 20 may calculate values for sub-integer pixel positions of reference pictures stored in DPB 66. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in DPB 66. As discussed in more detail below, the motion vector for a block may be determined by a motion vector predictor from a candidate list of neighbor blocks. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation, possibly performing interpolations to sub-pixel precision. Upon receiving the motion vector for the PU of the current video block, motion compensation unit 44 may locate the predictive block to which the motion vector points in one of the reference picture lists. Video encoder 20 forms a residual video block by subtracting pixel values of the predictive block from the pixel values of the current video block being coded, forming pixel difference values. The pixel difference values form residual data for the block, and may include both luma and chroma difference components. Summer 50 represents the component or components that perform this subtraction operation. Motion compensation unit 44 may also generate syntax elements associated with the video blocks and the video slice for use by video decoder 30 in decoding the video blocks of the video slice.

After prediction processing unit 41 generates the predictive block for the current video block, either via intra prediction or inter prediction, video encoder 20 forms a residual video block by subtracting the predictive block from the current video block. The residual video data in the residual block may be included in one or more TUs and applied to transform processing unit 52. Transform processing unit 52 transforms the residual video data into residual transform coefficients using a transform, such as a discrete cosine transform (DCT) or a conceptually similar transform. Transform processing unit 52 may convert the residual video data from a pixel domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. In another example, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy encoding methodology or technique. Following the entropy encoding by entropy encoding unit 56, the encoded bitstream may be transmitted to video decoder 30, or archived for later transmission or retrieval by video decoder 30. Entropy encoding unit 56 may also entropy encode the motion vectors and the other syntax elements for the current video slice being coded.

Inverse quantization unit 58 and inverse transform processing unit 60 apply inverse quantization and inverse transformation, respectively, to reconstruct the residual block in the pixel domain for later use as a reference block of a reference picture. Motion compensation unit 44 may calculate a reference block by adding the residual block to a predictive block of one of the reference pictures within one of the reference picture lists. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed block.

Filter unit 64 filters the reconstructed block (e.g. the output of summer 62) and stores the filtered reconstructed block in DPB 66 for uses as a reference block. The reference block may be used by motion estimation unit 42 and motion compensation unit 44 as a reference block to inter-predict a block in a subsequent video frame or picture. Although not explicitly shown in FIG. 2, video encoder 20 may include additional filters such as a deblock filter, a sample adaptive offset (SAO) filter, or other types of loop filters. A deblock filter may, for example, apply deblocking filtering to filter block boundaries to remove blockiness artifacts from reconstructed video. An SAO filter may apply offsets to reconstructed pixel values in order to improve overall coding quality. Additional loop filters (in loop or post loop) may also be used.

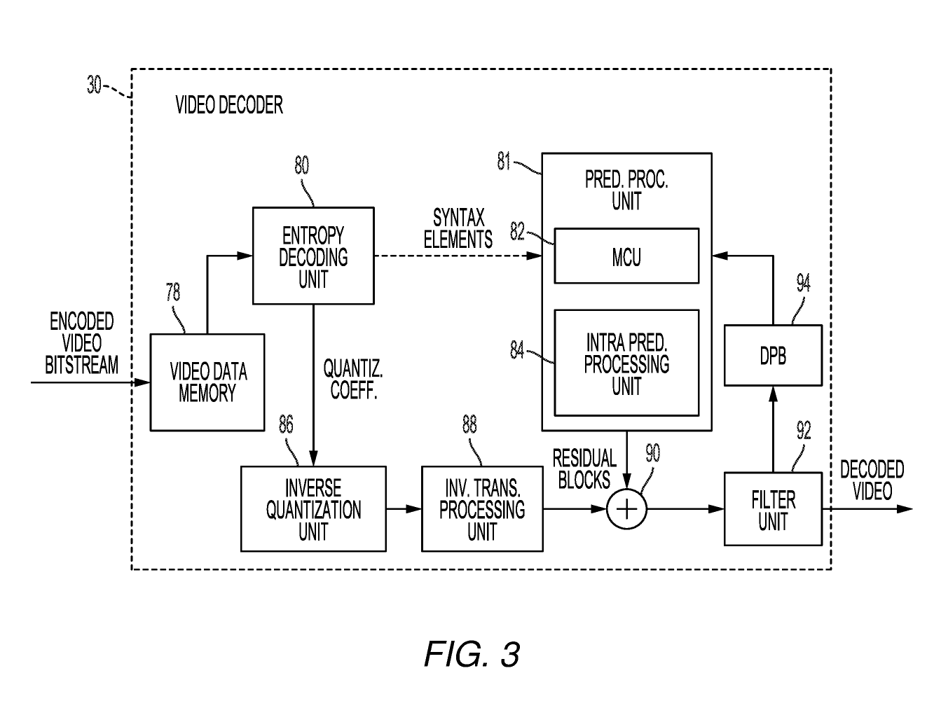

FIG. 3 is a block diagram illustrating an example video decoder 30 that may implement the techniques described in this disclosure. Video decoder 30 of FIG. 3 may, for example, be configured to receive the signaling described above with respect to video encoder 20 of FIG. 2. In the example of FIG. 3, video decoder 30 includes video data memory 78, entropy decoding unit 80, prediction processing unit 81, inverse quantization unit 86, inverse transform processing unit 88, summer 90, filter unit 92, and DPB 94. Prediction processing unit 81 includes motion compensation unit 82 and intra prediction processing unit 84. Video decoder 30 may, in some examples, perform a decoding pass generally reciprocal to the encoding pass described with respect to video encoder 20 from FIG. 2.

During the decoding process, video decoder 30 receives an encoded video bitstream that represents video blocks of an encoded video slice and associated syntax elements from video encoder 20. Video decoder 22 stores the received encoded video bitstream in video data memory 78. Video data memory 78 may store video data, such as an encoded video bitstream, to be decoded by the components of video decoder 30. The video data stored in video data memory 78 may be obtained, for example, via link 16, from storage device 26, or from a local video source, such as a camera, or by accessing physical data storage media. Video data memory 78 may form a coded picture buffer (CPB) that stores encoded video data from an encoded video bitstream. DPB 94 may be a reference picture memory that stores reference video data for use in decoding video data by video decoder 30, e.g., in intra- or inter-coding modes. Video data memory 78 and DPB 94 may be formed by any of a variety of memory devices, such as DRAM, SDRAM, MRAM, RRAM, or other types of memory devices. Video data memory 78 and DPB 94 may be provided by the same memory device or separate memory devices. In various examples, video data memory 78 may be on-chip with other components of video decoder 30, or off-chip relative to those components.

Entropy decoding unit 80 of video decoder 30 entropy decodes the video data stored in video data memory 78 to generate quantized coefficients, motion vectors, and other syntax elements. Entropy decoding unit 80 forwards the motion vectors and other syntax elements to prediction processing unit 81. Video decoder 30 may receive the syntax elements at the video slice level and/or the video block level.

When the video slice is coded as an intra-coded (I) slice, intra prediction processing unit 84 of prediction processing unit 81 may generate prediction data for a video block of the current video slice based on a signaled intra prediction mode and data from previously decoded blocks of the current frame or picture. When the video frame is coded as an inter-coded slice (e.g., B slice or P slice), motion compensation unit 82 of prediction processing unit 81 produces predictive blocks for a video block of the current video slice based on the motion vectors and other syntax elements received from entropy decoding unit 80. The predictive blocks may be produced from one of the reference pictures within one of the reference picture lists. Video decoder 30 may construct the reference frame lists, List 0 and List 1, using default construction techniques based on reference pictures stored in DPB 94.

Motion compensation unit 82 determines prediction information for a video block of the current video slice by parsing the motion vectors and other syntax elements, and uses the prediction information to produce the predictive blocks for the current video block being decoded. For example, motion compensation unit 82 uses some of the received syntax elements to determine a prediction mode (e.g., intra- or inter-prediction) used to code the video blocks of the video slice, an inter-prediction slice type (e.g., B slice or P slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 82 may also perform interpolation based on interpolation filters. Motion compensation unit 82 may use interpolation filters as used by video encoder 20 during encoding of the video blocks to calculate interpolated values for sub-integer pixels of reference blocks. In this case, motion compensation unit 82 may determine the interpolation filters used by video encoder 20 from the received syntax elements and use the interpolation filters to produce predictive blocks.

Inverse quantization unit 86 inverse quantizes, i.e., de quantizes, the quantized transform coefficients provided in the bitstream and decoded by entropy decoding unit 80. The inverse quantization process may include use of a quantization parameter calculated by video encoder 20 for each video block in the video slice to determine a degree of quantization and, likewise, a degree of inverse quantization that should be applied. Inverse transform processing unit 88 applies an inverse transform, e.g., an inverse DCT, an inverse integer transform, or a conceptually similar inverse transform process, to the transform coefficients in order to produce residual blocks in the pixel domain.

After prediction processing unit 81 generates the predictive block for the current video block using, for example, intra or inter prediction, video decoder 30 forms a reconstructed video block by summing the residual blocks from inverse transform processing unit 88 with the corresponding predictive blocks generated by motion compensation unit 82. Summer 90 represents the component or components that perform this summation operation. Filter unit 92 filters the reconstructed video block using, for example, one or more of the ALF techniques, SAO techniques, deblocking techniques or other such filtering techniques.

Although not explicitly shown in FIG. 2, video decoder 30 may also include one or more of a deblocking filter, an SAO filter, or other types of filters. Other loop filters (either in the coding loop or after the coding loop) may also be used to smooth pixel transitions or otherwise improve the video quality. The decoded video blocks in a given frame or picture are then stored in DPB 94, which stores reference pictures used for subsequent motion compensation. DPB 94 may be part of or separate from additional memory that stores decoded video for later presentation on a display device, such as display device 32 of FIG. 1.

In particular, with reference to operation of inter prediction processing units 44 and motion compensation unit 82, to code a block (e.g., of a prediction unit (PU) of video data), a predictor for the block is first derived. The predictor can be derived either through intra (I) prediction (i.e. spatial prediction) or inter (P or B) prediction (i.e. temporal prediction). Hence, some prediction units may be intra-coded (I) using spatial prediction with respect to neighbouring reference blocks in the same picture, and other prediction units may be inter-coded (P or B) with respect to reference blocks in other pictures. In some cases, a reference block may be in the same picture. It is noted that the terms “picture” and “frame” are generally used interchangeably in the current application.

Upon identification of a predictor, the difference between the original video data block and its predictor is calculated. This difference is also called the prediction residual, and refers to the pixel value differences between the pixels of the block to be coded and corresponding pixels of the reference block, i.e., predictor. To achieve better compression, the prediction residual (i.e., the array of pixel difference values) is generally transformed, e.g., using a discrete cosine transform (DCT), integer transform, Karhunen-Loeve (K-L) transform, or other transform.

Coding a block using inter-prediction involves calculating a motion vector between a current block and a block in a reference picture. Motion information thus includes both a motion vector and an indication of the reference picture. Motion vectors are calculated through a process called motion estimation (or motion search). A motion vector, for example, may indicate the displacement of a prediction unit in a current picture relative to a reference sample of a reference picture. A reference sample may be a block that is found to closely match the portion of the CU including the PU being coded in terms of pixel difference, which may be determined by sum of absolute difference (SAD), sum of squared difference (SSD), or other difference metrics. The reference sample may occur anywhere within a reference picture or reference slice. In some examples, the reference sample may occur at a fractional pixel position. Upon finding a portion of the reference picture that best matches the current portion, the encoder determines the current motion vector for the current portion as the difference in the location from the current portion to the matching portion in the reference picture (i.e., from the center of the current portion to the center of the matching portion).

In some examples, an encoder may signal the motion vector for each portion in the encoded video bitstream. The signaled motion vector is used by the decoder to perform motion compensation in order to decode the video data. However, signaling the original motion vector directly may result in less efficient coding, as a large number of bits are typically needed to convey the information.

Rather than directly signaling the original motion vector, the encoder may predict a motion vector for each partition, i.e., for each PU. In performing this motion vector prediction, the encoder may select a set of candidate motion vectors determined from spatially neighboring blocks in the same picture as the current portion or a candidate motion vector determined from a co-located block in a reference picture. The encoder may perform motion vector prediction, and if needed, signal the prediction difference rather than signal an original motion vector to reduce bit rate in signaling. The candidate motion vectors from the spatially neighboring blocks may be referred to as spatial MVP candidates, whereas the candidate motion vector from the co-located block in another reference picture may be referred to as temporal MVP candidate.

For each block, various types of motion information may be available. The motion information includes motion information for forward and backward prediction directions. In some embodiments, forward and backward prediction directions are two prediction directions corresponding to different reference picture lists, e.g., reference picture list 0 (RefPicList0) and reference picture list 1 (RefPicList1) of a current picture or slice. The terms “forward” and “backward” do not necessarily have a geometry meaning. Instead, they are used to distinguish which reference picture list a motion vector is based on. Forward prediction means the prediction formed based on reference list 0, while backward prediction means the prediction formed based on reference list 1. In case both reference list 0 and reference list 1 are used to form a prediction for a given block, it is called bi-directional prediction.

For a given picture or slice, if only one reference picture list is used, every block inside the picture or slice is forward predicted. If both reference picture lists are used for a given picture or slice, a block inside the picture or slice may be forward predicted, or backward predicted, or bi-directionally predicted.

For each prediction direction, the motion information contains a reference index and a motion vector. A reference index is used to identify a reference picture in the corresponding reference picture list (e.g. RefPicList0 or RefPicList1). A motion vector has both a horizontal and a vertical component, with each indicating an offset value along horizontal and vertical direction respectively. In some descriptions, for simplicity, the word of “motion vector” may be used interchangeably with motion information, to indicate both the motion vector and its associated reference index.

Examples of Block Structure in Video Codecs

Using HEVC as a starting point, a video codec may employ a block structure using a largest coding unit (LCU) in a slice is called a coding tree block (CTB) or coding tree unit (CTU). A CTB contains a quad-tree the nodes of which are coding units.

The size of a CTB can be ranges from 16×16 to 64×64 in the HEVC main profile (although technically 8×8 CTB sizes can be supported). A coding unit (CU) could be the same size of a CTB although and as small as 8×8. Each coding unit is coded with one mode. When a CU is inter coded, it may be further partitioned into 2 or 4 prediction units (PUs) or become just one PU when further partition doesn't apply. When two PUs are present in one CU, they can be half size rectangles or two rectangle size with ¼ or ¾ size of the CU.

When the CU is inter coded, one set of motion information is present for each PU. In addition, each PU is coded with a unique inter-prediction mode to derive the set of motion information.

### Motion Vector Prediction

Using the HEVC standard as an exemplary starting point, there are two inter prediction modes, named merge (skip is considered as a special case of merge) and advanced motion vector prediction (AMVP) modes respectively for a prediction unit (PU).

In either AMVP or merge mode, a motion vector (MV) candidate list is maintained for multiple motion vector predictors. The motion vector(s), as well as reference indices in the merge mode, of the current PU are generated by taking one candidate from the MV candidate list.

The MV candidate list contains up to 5 candidates for the merge mode and only two candidates for the AMVP mode. A merge candidate may contain a set of motion information, e.g., motion vectors corresponding to both reference picture lists (list 0 and list 1) and the reference indices. If a merge candidate is identified by a merge index, the reference pictures are used for the prediction of the current blocks, as well as the associated motion vectors are determined. However, under AMVP mode for each potential prediction direction from either list 0 or list 1, a reference index needs to be explicitly signaled, together with an MV predictor (MVP) index to the MV candidate list since the AMVP candidate contains only a motion vector. In AMVP mode, the predicted motion vectors can be further refined.

As can be seen above, a merge candidate corresponds to a full set of motion information while an AMVP candidate contains just one motion vector for a specific prediction direction and reference index.

The candidates for both modes are derived similarly from the same spatial and temporal neighboring blocks.

Spatial Neighboring Candidates

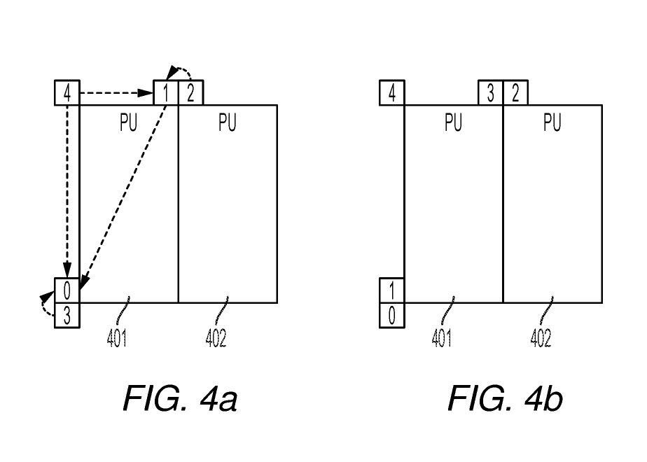

FIGS. 4a and 4b illustrate examples of two PUs 401 and 402 along with neighboring blocks at positions labeled according to a derivation order for a motion vector candidate list. Example spatial MV candidates are derived from the neighboring blocks shown on FIG. 4a, for a specific PU (e.g., PU 401 shown with neighboring PU 402), although the techniques generating the candidates from the blocks differ for merge and AMVP modes. In merge mode, in this example, up to four spatial MV candidates can be derived with the orders showed on FIG. 4a with numbers, and the order is the following: left (0, A1), above (1, B1), above right (2, B0), below left (3, A0), and above left (4, B2), as shown in FIG. 4a.

In AVMP mode, the neighboring blocks are divided into two groups: left group comprising the block at positions labeled 0 and 1, and above group comprising the blocks the blocks at positions labeled 2, 3, and 4 as shown on FIG. 4b. For each group, the potential candidate in a neighboring block referring to the same reference picture as that indicated by the signaled reference index has the highest priority to be chosen to form a final candidate of the group. It is possible that all neighboring blocks do not contain a motion vector pointing to the same reference picture. Therefore, if such a candidate cannot be found, the first available candidate will be scaled to form the final candidate, thus the temporal distance differences can be compensated.

Temporal Motion Vector Prediction in HEVC

Temporal motion vector predictor (TMVP) candidate, if enabled and available, is added into the MV candidate list after spatial motion vector candidates. The process of motion vector derivation for TMVP candidate may be the same for both merge and AMVP modes, however the target reference index for the TMVP candidate in the merge mode is always, in HEVC, set to 0.

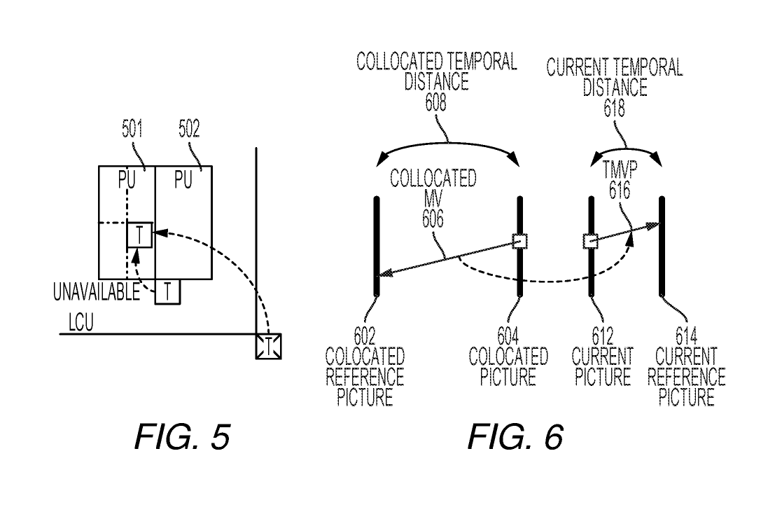

FIG. 5 is a diagram illustrating two example PUs 501 and 502 with respect to TMVP candidate generation. The primary block location for TMVP candidate derivation is the bottom right block outside of the collocated PU 501 as shown in FIG. 5 as a block “T”, to compensate the bias to the above and left blocks used to generate spatial neighboring candidates. However, if that block is located outside of the current CTB row or motion information is not available, the block is substituted with a center block of the PU.

FIG. 6 is a diagram illustrating the relationship between a motion vector 606 and a TMVP candidate 616. A motion vector for TMVP candidate 616 for the current picture 612 and current reference picture 614 is derived from the co-located PU of the co-located picture 604, indicated in the slice level. The motion vector for the co-located PU is identified as a collocated MV 606. Similar to temporal direct mode in AVC, to derive the TMVP candidate motion vector, the co-located MV is scaled to compensate the temporal distance differences 608, 618.

Other Aspects of Motion Prediction

Several aspects of merge and AMVP modes are provided as context as follows:

Motion Vector Scaling:

It is assumed that the value of motion vectors is proportional to the distance of pictures in the presentation time. A motion vector associates two pictures, the reference picture, and the picture containing the motion vector (namely the containing picture). When a motion vector is utilized to predict the other motion vector, the distance of the containing picture and the reference picture is calculated based on the Picture Order Count (POC) values.

For a motion vector to be predicted, both its associated containing picture and reference picture may be different. Therefore, a new distance (based on POC) is calculated. And the motion vector is scaled based on these two POC distances. For a spatial neighboring candidate, the containing pictures for the two motion vectors are the same, while the reference pictures are different. In HEVC, motion vector scaling applies to both TMVP and AMVP for spatial and temporal neighboring candidates.

Artificial Motion Vector Candidate Generation:

If a motion vector candidate list is not complete, artificial motion vector candidates are generated and inserted at the end of the list until it will have all candidates.

In merge mode, there are two types of artificial MV candidates: combined Bi-prediction candidate derived only for B-slices and default fixed candidates. Only zero candidate is used for AMVP if the first type doesn't provide enough artificial candidates.

For each pair of candidates that are already in the candidate list and have necessary motion information, bi-directional combined motion vector candidates are derived by a combination of the motion vector of the first candidate referring to a picture in the list 0 and the motion vector of a second candidate referring to a picture in the list 1.

Pruning Process for Candidate Insertion:

Candidates from different blocks may happen to be the same, which decreases the efficiency of a merge/AMVP candidate list. A pruning process is applied to solve this problem. It compares one candidate against the others in the current candidate list to avoid inserting identical candidate in certain extent. To reduce the complexity, only limited numbers of pruning process is applied instead of comparing each potential one with all the other existing ones.

### Affine Motion Prediction

To address other kinds of motion, as noted above, an affine transform motion compensation prediction may be applied to improve the coding efficiency. If a block follows one form of affine motion model, the MV of position (x, y) in the block can be determined by the affine motion model:

$$\{ \begin{matrix}{v}_{x} = ax + by + c \\ {v}_{y} = dx + ey + f\end{matrix} \qquad ( 1 )$$

where a, b, c, d, e and f are affine parameters.

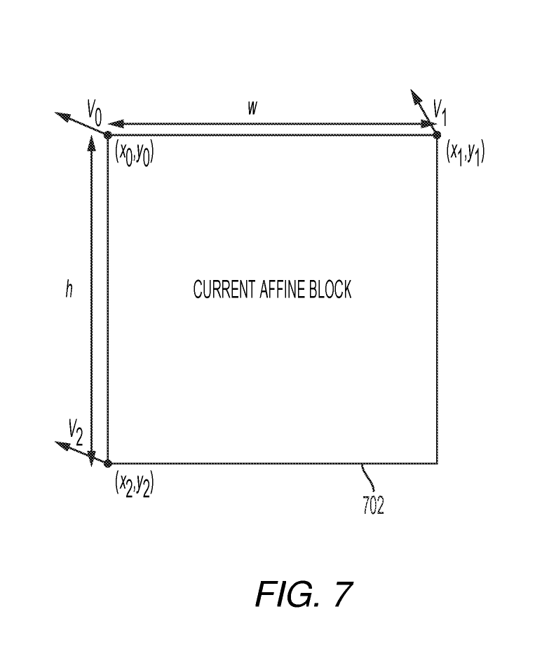

FIG. 7 is a diagram illustrating a current block 702 encoded using one example of an affine model. As shown in FIG. 7, the 6-parameter affine motion model can be represented by the motion vector ν₀ of the top-left control point (x₀, y₀), the motion vector ν₁ of the top-right control point (x₁, y₁) and the motion vector ν₂ of the top-right control point (x₂, y₂). With the assumption that the top-left control point is the origin of the coordinate system, which means (x₀, y₀)=(0, 0), the MV of position (x, y) in the block block is described by the following equation:

$$\{ \begin{matrix}{v}_{x} = \frac{( {v}_{1 x} - {v}_{0 x} )}{w} x + \frac{( {v}_{2 x} - {v}_{0 x} )}{h} y + {v}_{0 x} \\ {v}_{y} = \frac{( {v}_{1 y} - {v}_{0 y} )}{w} x + \frac{( {v}_{2 y} - {v}_{0 y} )}{h} y + {v}_{0 y}\end{matrix} \qquad ( 2 )$$

Where (ν₀ₓ, ν₀ₓ) is motion vector of the top-left corner control point, (ν₁ₓ, ν_{1y}) is motion vector of the top-right corner control point, (ν₂ₓ, ν_{2y}) is motion vector of the bottom-left corner control point, w=(x₁−x₀) is the horizontal distance between the top-left and top-right control points, and h=(y₂−y₀) is the vertical distance between the top-left and bottom-left control points.

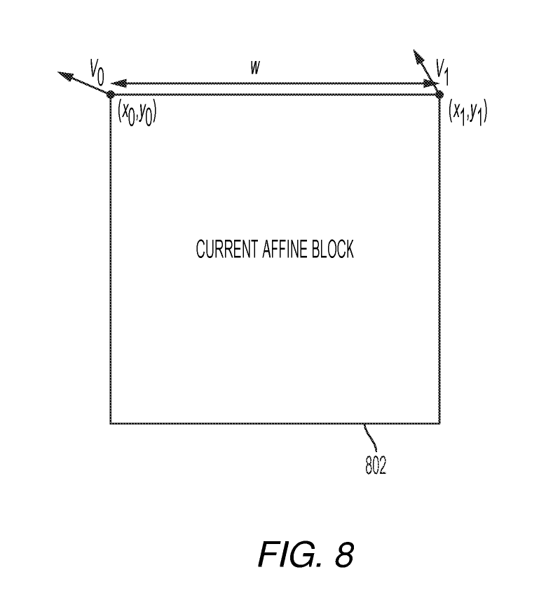

FIG. 8 is a diagram illustrating a current block encoded as an affine block 802 using another affine model. For example, in JEM version 7, the affine motion model is simplified to a 4-parameter affine motion model by assuming a=e and b=−d in equation (1):

$$\{ \begin{matrix}{v}_{x} = ax - by + c \\ {v}_{y} = bx + ay + f\end{matrix} \qquad ( 3 )$$

The 4-parameter affine motion model is then represented by the motion vector ν₀ of the top-left control point (x₀, y₀) which is assumed as the origin point and the motion vector ν₁ of the top-right control point (x₁, y₁).

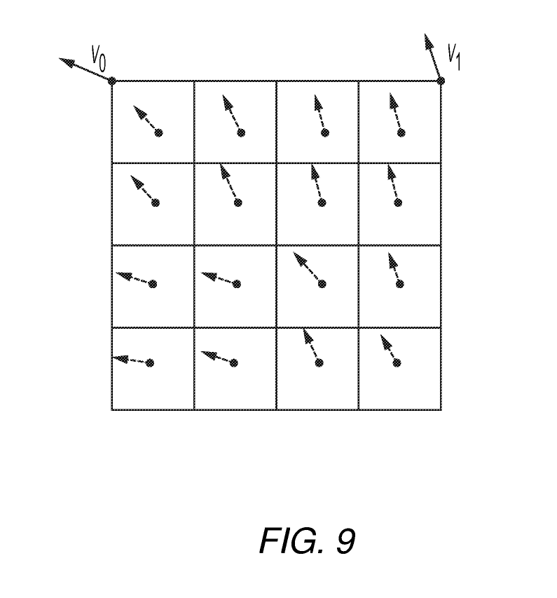

FIG. 9 is a diagram illustrating a motion compensated prediction (MCP) motion vector (MV) field. In FIG. 9, the MV of each sub-block (e.g. 4×4 block) is interpolated by the MVs of the control points; the MV is then used to perform motion compensation prediction (MCP) for each sub-block As shown in FIG. 9, the affine motion field of the block is described by two control point motion vectors. The motion vector field (MVF) of a block is described by the following equation:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} \qquad ( 4 )$$

Where (ν₀ₓ, ν_{0y}) is motion vector of the top-left corner control point, and (ν_{1y}, ν_{1y}) is motion vector of the top-right corner control point and w=(x₁−x₀) is the horizontal distance between the top-left and top-right control points.

FIG. 9 is a diagram illustrating a current block encoded as an affine block 902 using another, simplified, affine model. In particular, in order to further simplify the motion compensation prediction, block based affine transform prediction may be applied. To derive motion vector of each sub-block, the motion vector of the center sample of each sub-block 902, as shown in FIG. 9, is calculated according to equation (4). In the illustrated example, motion is rounded to 1/16 fraction accuracy. The motion compensation interpolation filters are applied to generate the prediction of each sub-block 902 with derived motion vector. The interpolated motion vectors for each sub-block within the affine block is named as MCP motion vector field (MVF) in the following context. Note that, the sub-block size can vary depending on the MV difference between control points.

After MCP, the high accuracy motion vector of each sub-block is rounded and saved as the same accuracy as the normal motion vector. In JEM and HEVC, the motion vectors for each inter prediction CU or PU are stored for the MV prediction of the other inter blocks. The store unit for motion vectors is a 4×4 block. In an example of JEM, the interpolated MVs of an affine block are generated and store for each 4×4 block.

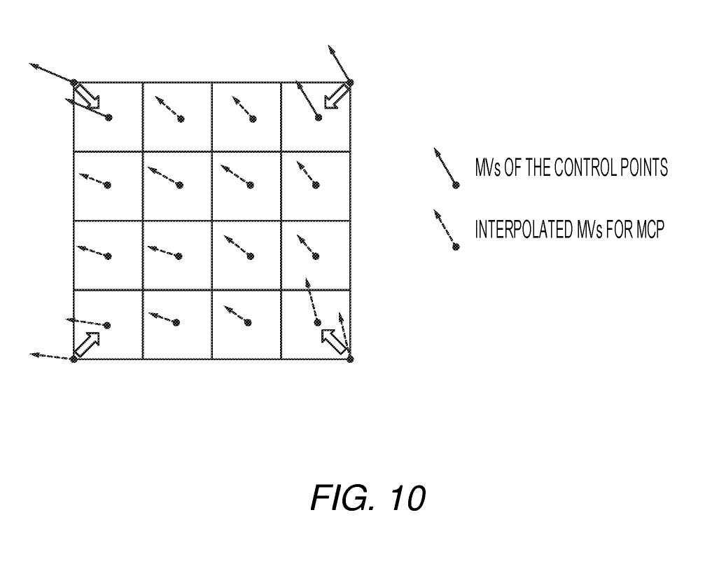

However, since the MVs of the control points may be used for the following blocks, the stored MVs for the corner 4×4 blocks are the MVs of the control points instead of the associated MVs used for MCP as shown in FIG. 10. FIG. 10 is a diagram illustrating a stored MV field. In FIG. 10, the MV of each sub-block (a 4×4 block for illustration) is interpolated by the MVs of the control point. The stored MV of the four corner four sub-blocks are the MVs of the nearby control points. Note that, in one version of JEM, the MVs of the bottom-left and bottom-right control points are also generated by the MVs of the top-left and top-right control points.

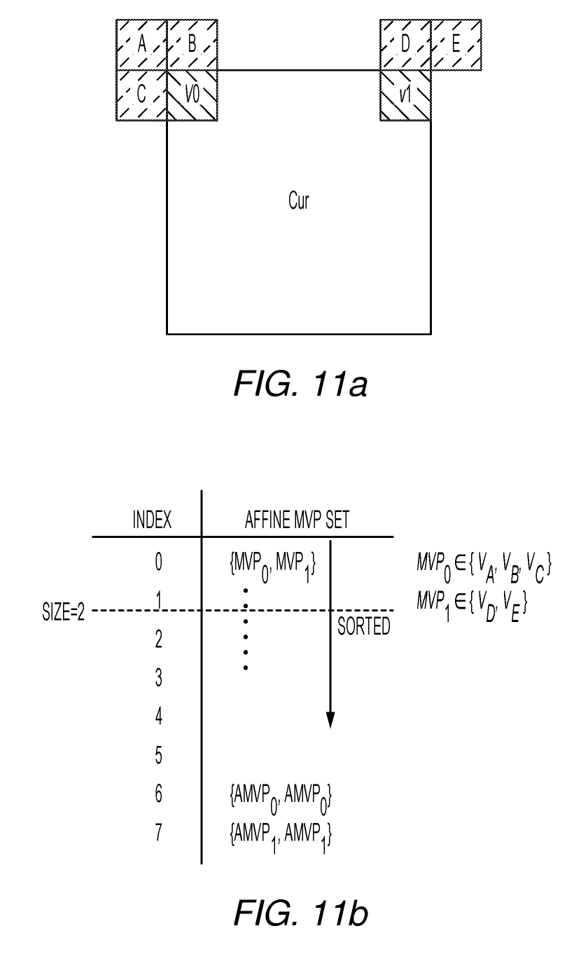

Further to the example of one version of JEM, there are two affine motion modes: affine inter (AF_INTER) mode and affine merge (AF_MERGE) mode. FIG. 11a illustrates an example motion vector for an affine inter prediction mode. FIG. 11b is a table illustrating an example affine motion vector predictor set for the example of FIG. 11a. For CUs with both width and height larger than 8, AF_INTER mode can be applied. An affine flag in CU level is signalled in the bitstream to indicate whether AF_INTER mode is used. In this mode, a candidate list with motion vector set {(MVP₀, MVP₁)|MVP₀={v_{A}, v_{B}, v_{C}}, MVP₁={v_{D}, v_{E}}} is constructed using the neighbour blocks.

As shown in FIGS. 11a and 11b, MVP₀ is selected from the motion vectors of the block A, B or C. The motion vector from the neighbour block is scaled according to the reference list and the relationship among the POC of the reference for the neighbour block, the POC of the reference for the current CU and the POC of the current CU. And the approach to select MVP₁ from the neighbour block D and E is similar. If the number of candidate list is smaller than 2, the list is padded by the motion vector pair composed by duplicating each of the AMVP candidates {AMVP₀, AMVP₀} and {AMVP₁, AMVP₁}. When the candidate list is larger than 2, the candidates are firstly sorted according to the consistency of the neighbouring motion vectors (similarity of the two motion vectors in a pair candidate) and only the first two candidates are kept as shown in the FIG. 11b. RD cost check may be used to determine which motion vector set candidate is selected as the control point motion vector prediction (CPMVP) of the current CU. In some embodiments, an index indicating the position of the CPMVP in the candidate list is signalled in the bit stream. After the CPMVP of the current affine CU is determined, affine motion estimation is applied and the control point motion vector (CPMV) is found. The difference of the CPMV and the CPMVP may also be signalled in the bit stream.

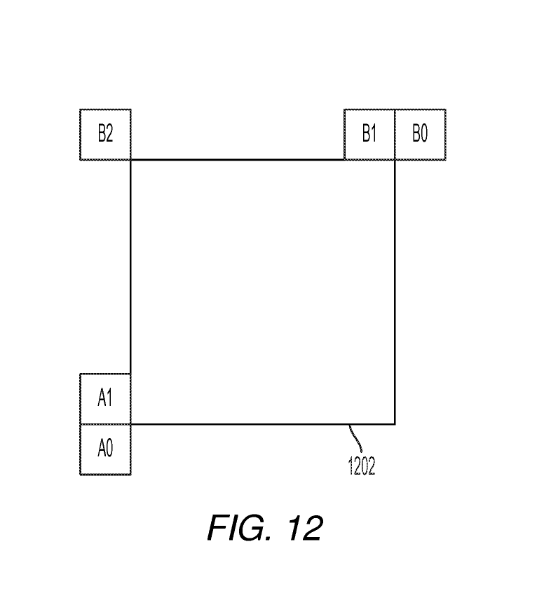

When a CU is applied in affine merge (AF_MERGE) mode, the first block may be coded with affine mode from the valid neighbour reconstructed blocks based on a specified visiting order, for example: A1→B1→B0→A0→B2. FIG. 12 is a block diagram illustrating a current block 1202 and neighboring candidate blocks. In one example, selection order for the candidate block is from left, above, above right, left bottom to above left.

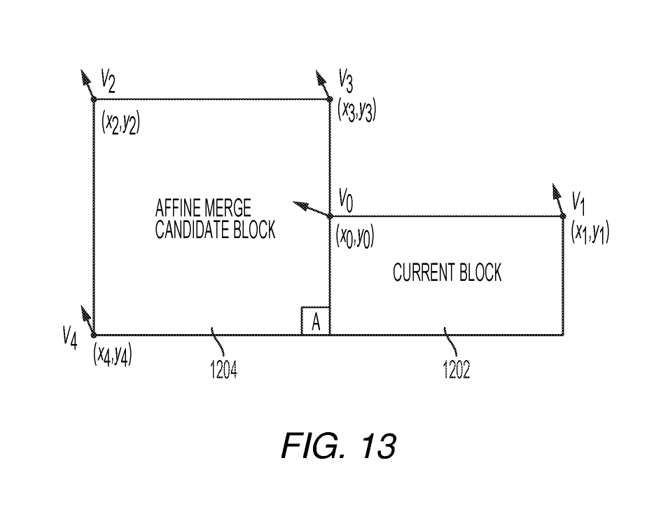

FIG. 13 is a block diagram illustrating the current block 1202 and an affine neighboring block 1204. If the neighbour left bottom block A is coded in affine mode, the motion vectors ν₂, ν₃ and ν₄ of the top left corner, above right corner and left bottom corner of the CU which contains the block A are derived. The motion vector ν₀ of the top left corner on the current CU may be extrapolated according to ν₂, ν₃ and ν₄ using equation (5) by assuming (x₂, y₂) is the origin point which means (x₂, y₂)=(0, 0). Further, the motion vector ν₁ of the above right of the current CU is calculated in a similar way. The equation (5) is shown as below.

$$\{ \begin{matrix}{v}_{x} = \frac{( {v}_{3 x} - {v}_{2 x} )}{w} x + \frac{( {v}_{4 x} - {v}_{2 x} )}{h} y + {v}_{2 x} \\ {v}_{y} = \frac{( {v}_{3 y} - {v}_{2 y} )}{w} x + \frac{( {v}_{4 y} - {v}_{2 y} )}{h} y + {v}_{2 y}\end{matrix} \qquad ( 5 )$$

where (ν₂ₓ, ν_{2y}) is motion vector of the top-left corner control point (x₂, y₂), (ν₃ₓ, ν_{3y}) is motion vector of the top-right corner control point (x₃, y₃), (ν₄ₓ, ν_{4y}) is motion vector of the bottom-left corner control point (x₄, y₄) in the neighbor affine block, w=(x₃−x₂) is the horizontal distance between the top-left and top-right control points, and h=(y₄−y₂) is the vertical distance between the top-left and bottom-left control points.

After the CPMV of the current CU ν₀ and ν₁ are derived, according to the affine motion model equation (4), the MVF of the current CU is generated. In order to identify whether the current CU is coded with AF_MERGE mode, an affine flag is signalled in the bit stream when there is at least one neighbour block is coded in affine mode.

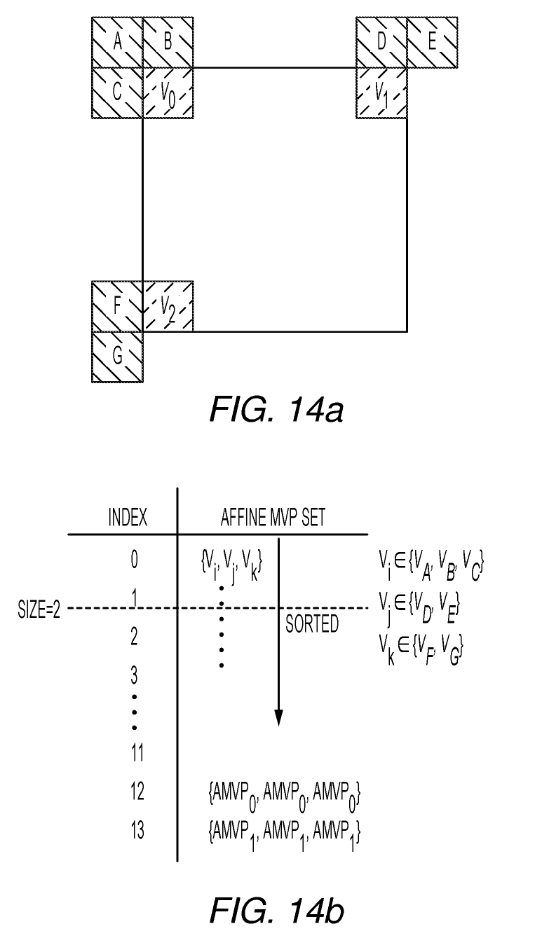

FIG. 14a illustrates another example motion vector for an affine inter prediction mode. FIG. 14b is a table illustrating an example affine motion vector predictor set for the example of FIG. 14a. In JVET-00062 (F. Zou, J. Chen, M. Karczewicz, X. Li, H.-C. Chuang, W.-J. Chien, “Improved affine motion prediction,” May 2016, available at http://phenix.it-sudparis.eu/jvet/doc_end_user/current_document.php?id=2660), it was proposed to adaptive select to use either 4-parameter affine motion model or 6-parameter affine motion model for each affine block in JEM. In 6-parameter affine model, there is no constraint on the scaling factors between horizontal and vertical directions. Three corner motion vectors are used to represent the 6-parameter model. Given the motion vectors at the three corners (illustrated in FIG. 14a), the MV of position (x, y) in the block block is described by the equation (2). Similar to the 4-parameter AF_INTER mode, a candidate list with motion vector set {(v₀, v₁, v₂)|v₀={v_{A}, v_{B}, v_{C}}, v₁={v_{D},v_{E}}, ν₂={v_{F},v_{G}}} for the 6-parameter AF_INTER mode is constructed using the neighbour blocks.

In general, the affine motion model is a 6-parameter motion model as shown in equation (1). In JEM-7.0, the affine motion model for a block is represented by the motion vectors of the control points (ν₀, ν₁). In JVET-00063, X. Zhao, A. Said, V. Seregin, M. Karczewicz, J. Chen, “EE2.7 related: Improved non-separable secondary transform,” May 2016, available at http://phenix.it-sudparis.eu/jvet/doc_end_user/current_document.php?id=2661, the affine motion model for a block can be further represented by the motion vectors of the control points (ν₀, ν₁, ν₂). However, it may be desirable to represent the affine motion model by signaling the parameters a, b, c, d, e, f in equation (1) or simplified 4 parameters. The affine motion model can also be further interpreted as equation (6) where Oₓ and O_{y} are the translation offsets, Sₓ and S_{y} are the scaling ratio in the x and y directions and ⊖ₓ and ⊖_{y} are the rotation angles.

$$\{ \begin{matrix}{v}_{x} = {s}_{x} * cos {θ}_{x} * x - {s}_{y} * Sin {θ}_{y} * y + {O}_{x} \\ {v}_{y} = {s}_{x} * sin {θ}_{x} * x + {s}_{y} * cos {θ}_{y} * y + {O}_{y}\end{matrix} \qquad ( 6 )$$

Since motion information predictors are derived from the reconstructed motion information of the previously reconstructed blocks, the motion parameters from previous reconstructed blocks are to be stored in a motion parameters buffer.

In a typical decoder design, a working buffer is used to store all the reconstructed data such as pixel values, coding information (e.g. skip mode, prediction mode, merge mode, FRUC mode) and also the reconstructed motion information (e.g. reference picture index, motion vectors) for a pre-defined working block size (e.g. CTU or so called LCU, largest coding unit). Typically, the working buffer uses a local memory with very low access latency such as cache, on-chip memory. For simplicity, the working block size is assumed as the CTU size in the following context of this invention. For each block within the CTU, if the predicting coding information is derived from the neighboring blocks within the same CTU, it only needs to fetch the data stored in the working buffer. However, when the prediction coding information is derived from the blocks outside the CTU which the current block belongs to, the prediction information then has to be fetched from a buffer outside the working buffer which may cause longer latency. To solve this issue, a line buffer is used to avoid long access latency.

A line buffer is a local memory with low access latency and is used to store the predicting coding information of the blocks outside the current working block (e.g. a working CTU) and the stored information is usually the one used for spatial prediction for the following blocks. It is a common practice that CTUs are encoded/decoded in a raster-scan order when it comes to a large-resolution video, and the reconstructed samples and other coding information are normally written to a distant/non-local memory area (e.g., DDR SRAM) after decoding the CTU, so that the local memory (normally of very limited size compared to the video data) can be released for encoding/decoding of subsequent CTUs. When starting to encode/decode the second CTU rows onwards, the reconstructed samples and other coding information from the bottom of the previous CTU row needs to be re-loaded into a local memory, such that the required data from the above CTU can be made available once the computation units access them during the encoding/decoding process.

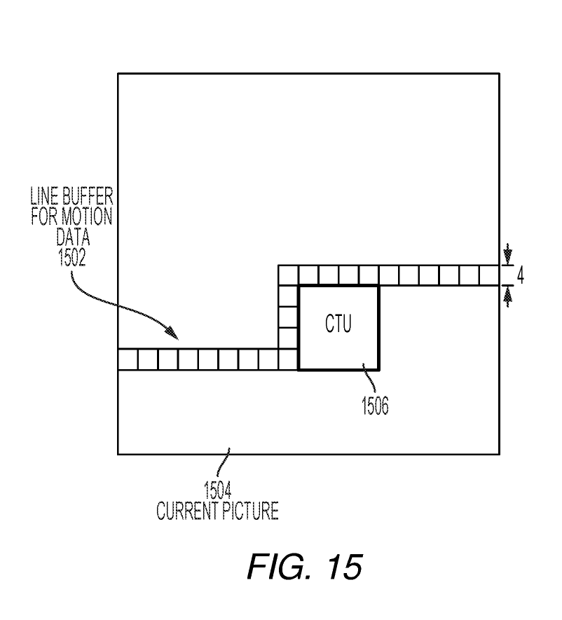

FIG. 15 is an illustration of a line buffer 1502 for a CTU 1506 of the current picture 1504. For example, in a typical implementation such as for HEVC, a line buffer is used to store the motion information of a line of 4×4 block across the picture width plus one CTU height for the purpose of spatial motion vector (MV) prediction. However, such a design has a need for improvement in the context of using affine motion models. For example, to derive affine motion predictors for an affine block (including affine inter mode and affine merge mode) in JEM, the motion vectors of the top-left, top-right and bottom-left corner 4×4 blocks are used to generate the affine MV predictors. However, when the neighboring affine blocks is located at upper CTU row, the motion information of the top-left, top-right corner blocks may not be stored in the motion data line buffer. Embodiments described in further detail below include MVP generation to be aligned with the MV line buffer design. Other embodiments include enlarging the line buffer or modify the selections of MVs stored in the MV line buffer. Such features described with respect to various examples may be used alone or in any suitable combination.

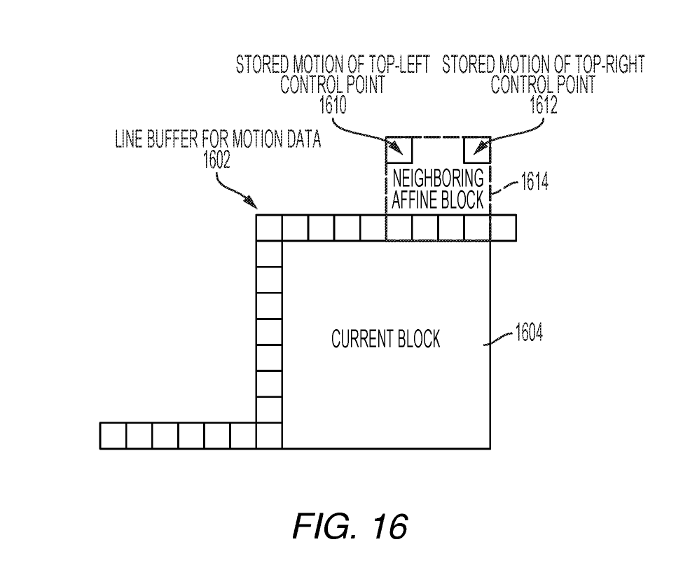

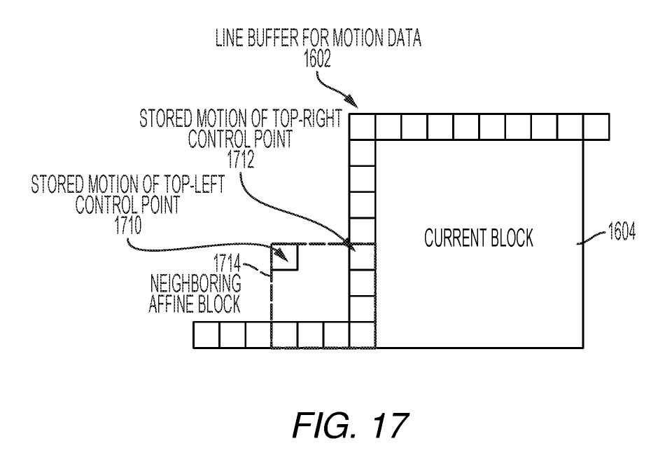

FIGS. 16 and 17 are diagrams illustrating a current block 1604 and a line buffer 1602. FIG. 16 illustrates a top neighboring affine block 1614 and control points 1610 and 1612. FIG. 17 illustrates a left neighboring affine block 1714 and control points 1710 and 1712. In one embodiment, MV prediction is prohibited or disabled when the MV prediction needs the motion information which is not stored in the MV line buffer. In one example, when the motion of the top-left 1610 and top-right control 1612 points of the neighboring block 1614 is not stored in the line buffer, the motion predictor derived using the affine motion model of that neighboring block is regarded as not available. Similarly, when the motion of the top-left 1710 and top-right control 1712 points of the neighboring block 1714 is not stored in the line buffer, the motion predictor derived using the affine motion model of that neighboring block is regarded as not available. Please note that in this case, partial motion of that neighboring block may be stored in the line buffer, the motion stored in the MV line buffer can still be used as regular motion predictor.

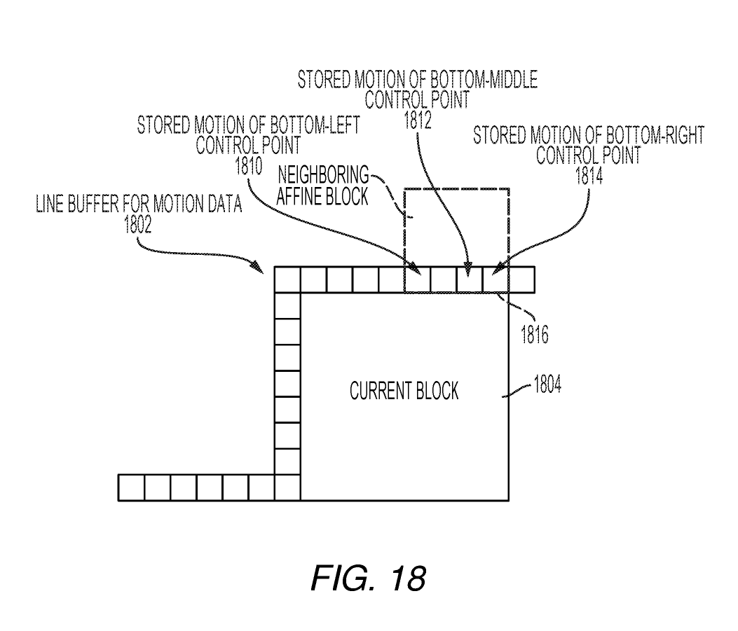

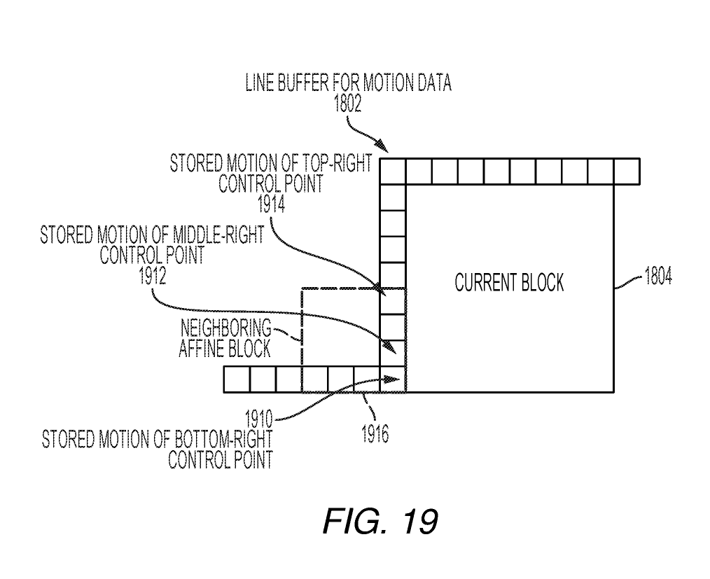

FIGS. 18 and 19 are diagrams illustrating a current block 1804 and a line buffer 1802 relative to another embodiment that includes modified motion vector prediction generation. FIG. 18 illustrates a top neighboring affine block 1816 and control points 1810, 1812, and 1814. FIG. 19 illustrates a left neighboring affine block 1916 and control points 1910, 1912, and 1914. Extending from JEM, for example, when the current block is coded as affine mode, the motion vector predictors of the top-left and top-right control points of the current block may be derived from the neighboring block which is also coded as affine mode. For example, as described above with respect to affine motion prediction in JEM, when current block is affine merge mode, the MV of the control points are generated using the motion of the top-left and top-right control points of one selected neighboring affine block (bottom-left control points may be used when 6-parameter affine models are used). However, the motion of the top-left and top-right control points of the neighboring affine blocks may not be stored in the line buffer. To fit the line buffer schemes, in this example, we modify the MV predictor generation of the applied affine motion model based on what control points are available in the line buffer.

The MV predictor generated from the above neighboring affine block 1816 is modified to use the bottom-left 1810 and bottom-right 1814 control points of the neighboring affine blocks. Similarly, the MV predictor generated from the left neighboring affine block 1916 may be modified to use the top-right 1914 and bottom-right control 1910 points of the neighboring affine block 1916.

When 6-parameter affine motion model is used, in some embodiments, the motion vectors of three control points are used to derive the affine motion model; furthermore, the three control points shall not all fall in the same straight line. Therefore, the MV predictor generated from the neighboring affine blocks 1816 and 1916 is modified to use the bottom-left 1810, bottom-middle 1812 and bottom-right 1814 control points of the above neighboring affine blocks 1816; and the top-right 1914, middle-right 1912 and bottom-right 1916 control points of the left neighboring affine blocks 1916 are used to derive the affine MVP as shown in FIGS. 18 and 19.

To further extend the concept, any three MVs among the MVs stored in the line buffer can be used to derive the MV predictors. In one such embodiment, the spatial neighboring block B as shown in FIG. 12 may not be used for affine MVP derivation considering the limitation of line buffer.

When 6-parameter affine motion model is used for the current block, some embodiments use only the MVs of two control points from the neighboring affine blocks and the MVs of the two control points are the ones selected from those MVs stored in the line buffer. In some embodiments, the coding device may only apply this example to the AFFINE_INTER mode where the three motion vector predictors located at the top-left, top-right, and the bottom-left corners are derived using the aforementioned control points. That is, the actual motion vector at the three corners are reconstructed by adding the motion vector difference signaled via bitstream and the motion vector predictors derived above, and the actual 6-parameter affine model is constructed using the three reconstructed motion vectors.

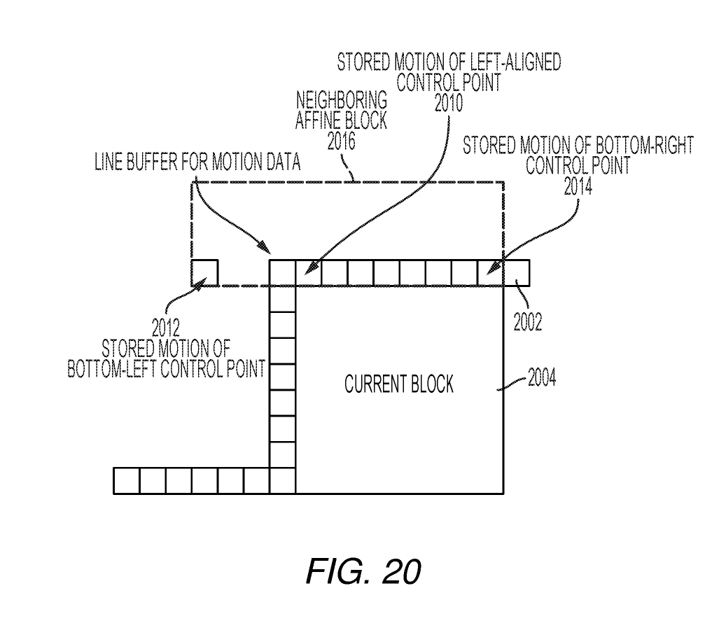

FIG. 20 is a diagram illustrating a current block 2004 and a line buffer 2002 relative to another embodiment that includes modified motion vector prediction generation. FIG. 20 illustrates a top neighboring affine block 2016 and control points 2010, 2012, and 2114. In this embodiment, in the case that motion of bottom-left control point is not stored in the line buffer for the above neighboring affine block 2016, some embodiments use another MV stored in the line buffer 2002. In some embodiments, the encoder/decoder may use the left-aligned control point 2010 which is the above block of the top-left corner of current block 2004. Yet in another example, embodiments use available left-most MV 2010 to replace the MV of bottom-left control point 2012. The same concept can also be applied to the case when the motion of top-right control point is not stored in the line buffer for the left neighboring affine block (not shown).

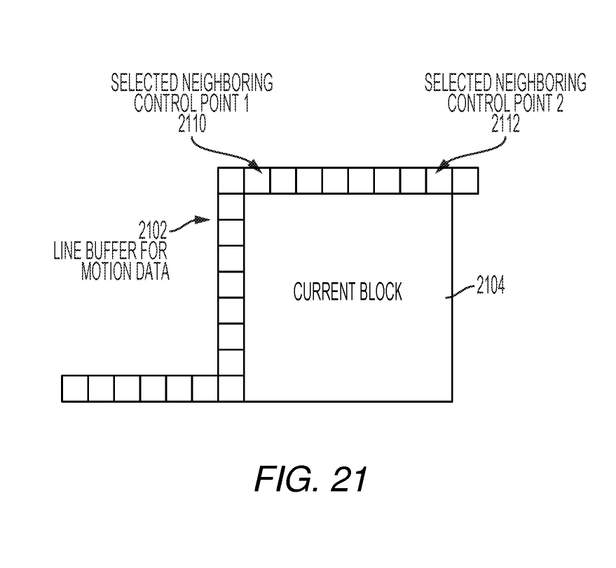

FIG. 21 is a diagram illustrating a current block 2104 and a line buffer 2102 relative to another embodiment that includes modified motion vector prediction generation. FIG. 21 illustrates top neighboring blocks and control points 2110, and 2112. In this example, to derive the affine MVP, the encoder/decoder can select the N MVs that are available from the line buffer 2012 to derive the affine MVP. N is a positive integer which represents the number of control point needed by the affine model (e.g. N=2 for 4-parameter affine motion model and N=3 for 6-parameter affine motion model). To fulfil the required number of variables to solve for the affine parameters, the control point can be chosen from arbitrary N positions of the immediate neighboring (for example, 4×4) blocks. The set of the position can be predefined, or can be signaled via for the sequence (e.g., the sequence parameter set), picture (e.g., picture parameter set), or the slice header. The conditions of such pre-definition can be based on the size of the block, or the aspect ratio of the block. For example, the MVs of the above blocks of top-left and top-right corner of current block (e.g. selected neighboring control point 1 2110 and selected neighboring control point 2 2112) are used to derive affine MV predictors. In another example, consider the case where the above block is of the same width as the current block and the above block is partitioned with a vertical, center-side triple tree. The two control points located at the top-left and the top-right corners may not fall into blocks which are coded as affine modes, while the middle block can be coded as affine. A search process may be performed to find the set of available control points, followed by a pruning process which selects the most reliable N, e.g., two or three control points to perform the final affine prediction.

Examples with Modified MV Stored for Affine Motion Mode Blocks

In some embodiments, since the MVs of the control points may be used for the following (in decoding order) blocks, the stored MVs for the corner 4×4 sub blocks are used as the MVs of the control points. In other words, the motion vectors for a control point are shifted to a motion vector that will be made available in the line buffer.

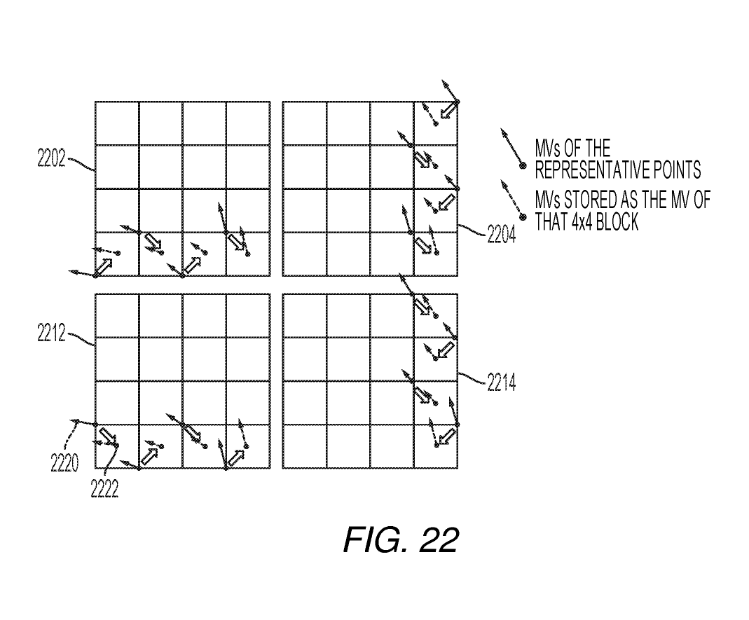

In some embodiments, for each bottom row of 4×4 MV stored blocks of an affine mode coded block, the representative points of each 4×4 block for MV store are shifted differently at even (or odd) coordinates. Here, the representative point is the point within a 4×4 block (sub-block) where the motion vector is generated based on an affine motion model. The generated MV is then stored as the MV of that 4×4 block to be used as MVP for following coding blocks. FIG. 22 is a diagram illustrating a number of motion compensated prediction motion vector fields 2202, 2204, 2212, and 2214. For example, as shown, the bottom row of 4×4 blocks 2202 and 2212 may use different representative points for MV store. For example, 2220 may be displayed to 2222. Note that while the displaced motion vectors are appropriate for derivation of affine models for subsequent blocks, the motion compensation process may use a separate set of motion vectors derived by the existing affine model to generate the prediction samples. In some embodiments, the representative points at even (or odd) coordinates are shifted differently. Hence, 6 parameter affine may be derived from one my line buffer from both a top and left neighbor.

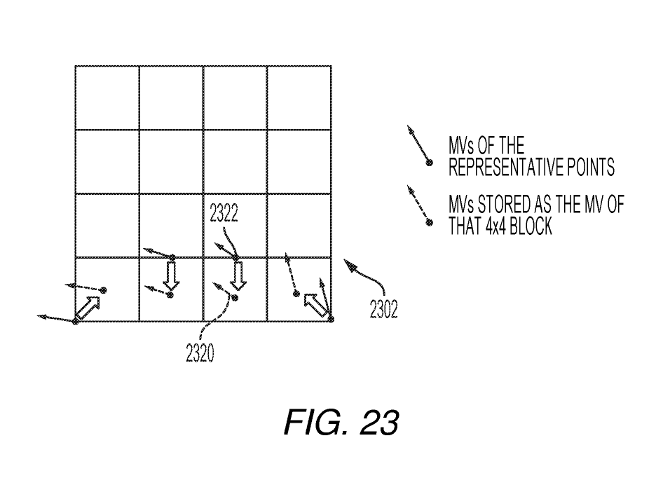

FIG. 23 is a diagram illustrating a motion compensated prediction motion vector field 2302. In this example, the MVs in the last 4×4-block row of each affine coded block, the non-corner 4×4 blocks will store the MVs 2320 of the top-middle point 2322 of each 4×4 block 2302.

### Examples of Extended MV Line Buffer

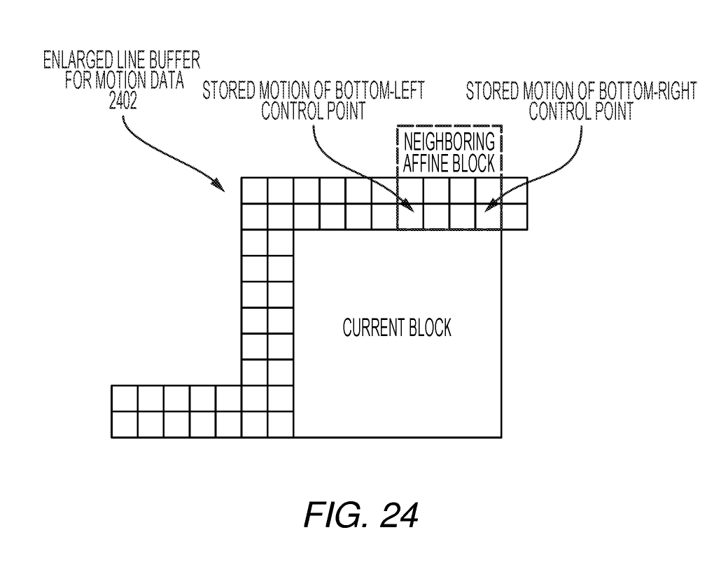

FIG. 24 is diagram illustrating an enlarged line buffer 2402 that, in this example, includes two-lines of motion information. When 6-parameter affine motion model is used, the motion vectors of three control points may be used to derive the affine motion parameters. Furthermore, the three control points should be selected so as to not fall in the same straight line. Therefore, in such embodiments, the MV line buffer is enlarged to store more neighboring MVs. For example, two-lines of motion buffer are used and three motion vectors are selected among the available neighboring my blocks as shown in FIG. 24.

Additional Buffer for the Affine Parameters

In this embodiment, an encoder/decoder uses additional buffers other than the motion vector buffers to store the affine parameters for each affine inter block (block can be coding unit (CU) or prediction unit (PU) as defined in HEVC). The bit-depth of the parameters buffer can be aligned with the bit-depth of the motion vector buffer or can be in any bit-depth (e.g. 8-bits, 10 bits, 16 bits or any other representations) for different applications.

In one example, the stored affine parameters can be any or all of the six or four parameters as described in equation 1 or 3.

In another example when the affine motion model is represented by the motion vectors of the control points as shown in equation 2 or 4, the stored affine parameters can also be any or all of the six or four parameters as described in equation 2 or 4. For example, in the simplified 4-parameter affine model used in JEM-7.0, the parameters ν₀ₓ, ν_{0y}, ν₁ₓ, v_{1y} are stored in the parameters buffers (the parameter w can be derived using the coded information). In another example, ν₀ₓ, ν_{0y},

$$\frac{( {v}_{1 x} - {v}_{0 x} )}{w} , \frac{( {v}_{1 y} - {v}_{0 y} )}{w}$$

are stored in the parameters buffers. It is noted that, MV difference between ν₀ and ν₁ can be represented in the unit of the smallest MV block size (such as 4×4 block). In this way, we can store the parameters

$$\frac{( {v}_{1 x} - {v}_{0 x} )}{( w / 4 )} and \frac{( {v}_{1 y} - {v}_{0 y} )}{( w / 4 )}$$

instead of

$$\frac{( {v}_{1 x} - {v}_{0 x} )}{w} and \frac{( {v}_{1 y} - {v}_{0 y} )}{w} .$$

### Additional Available Motion Vectors for Derivation of Affine Parameters

In some embodiments, a non-adjacent spatial motion vector predictor may use the motion vectors of the blocks which are not immediately adjacent to current block because the motion vector of the non-adjacent block can further improve the prediction efficiency. This is particularly the case when the correlation between the spatial motion vectors is strong enough for the motion information of the current block similar to that of non-adjacent blocks thus the motion information from the non-adjacent blocks can be good MVP candidates for the current block. In such systems, the non-adjacent spatial motion vector predictor (NA-SMVP) is used to derive the motion vector predictor for the motion information of current block; or the NA-SMVP can be directly re-used by the current block to perform inter-prediction. Some such embodiments adaptively incorporate the NA-SMVP together with the other MV predictors (e.g. regular SMVP, TMVP, synthetic MVPs) for MV prediction. Non-adjacent spatial motion vector predictor. In case more than one line or column buffer is used, the affine parameters can be derived using the available motion vector stored at these extra line buffers. For example, if the immediate neighbors are not coded as affine but the farther neighbors are, the motion vectors from the farther neighbors can be used as control points (e.g., the farther above points at the left-aligned and right aligned control points in FIG. 20).

In another example, if both the immediate neighbors and the farther neighbors are coded in affine mode, the set of multiple control points can be formed and a pruning process based on the sum of absolute difference between the set of projected motion vectors and the set of actual motion vectors can be used to select the set of actual control points. For example, if the control points in FIG. 20 and two additional control points located at 32 pixels above the immediate two control points, a set of four control points are formed. In case of 6-parameter affine model, only three control points are required to solve for the affine parameters, and there are four combination to select which three motion vectors should be chosen as the actual control points.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The techniques described herein may be implemented in hardware, software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

1. A method of encoding or decoding video data using affine motion predictors, the method comprising:
determining motion vectors for at least three affine control points from neighboring blocks of a current video block, the neighboring blocks comprising a top neighboring block, comprising:
determining for a top neighboring affine block that motion vectors of one or more control points of an affine motion model of the neighboring affine block is unavailable from a line buffer; and
based on the determination that the one or more control points are unavailable, determining one or more other motion vectors based on motion vectors the neighboring blocks that are stored in the line buffer;
generating a motion vector predictor using the determined other motion vectors stored in the line buffer; and
coding the video block based the generated motion vector predictor.

2. The method of claim 1, wherein the determined unavailable control points comprises a top-left or top-right control point and wherein the other motion vectors comprise a bottom-left or a bottom-right motion vector stored in the line buffer.

3. The method of claim 2, wherein each of the bottom-left and the bottom-right motion vectors are corresponding motion vectors of neighboring 4×4 blocks.

4. The method of claim 2, wherein the bottom-left and the bottom-right motion vector are corresponding motion vectors of a bottom-left and a bottom-right control point of the neighboring affine block.

5. The method of claim 4, wherein an affine motion model used to predict the current block comprises a 6-parameter affine motion model, and wherein the control points further comprises a bottom-middle control point.

6. The method of claim 1, wherein an affine motion model used to predict the current block comprises a 4-parameter affine motion model.

7. The method of claim 1, wherein an affine motion model used to predict the current block comprises a 4-parameter affine motion model.

8. The method of claim 1, wherein coding the video block comprises encoding the video block, comprising:
encoding data indicating that the video block is encoded based on the generated motion vector predictor;
generating a prediction block based on the generated motion vector predictor;
determining a residual based on the prediction block and the video block; and
encoding data indicative of the residual.

9. The method of claim 1, wherein coding the video block comprises decoding the video block, comprising:
decoding data indicating that the video block is encoded based on the generated motion vector predictor;
generating a prediction block based on the generated motion vector predictor;
decoding data indicative of a residual for the video block; and
decoding the video block using the prediction block and the residual.

10. An apparatus for encoding or decoding video data using affine motion predictors, the apparatus comprising:
a memory configured to store a line buffer comprising motion vectors of neighboring blocks of a current video block; and
a processor configured to:
determine motion vectors for at least three affine control points from neighboring blocks of the current video block, the neighboring blocks comprising a top neighboring block, comprising:
determine for a top neighboring affine block that motion vectors of one or more control points of an affine motion model of the neighboring affine block is unavailable from a line buffer; and
based on the determination that the one or more control points are unavailable, determine one or more other motion vectors based on motion vectors the neighboring blocks that are stored in the line buffer;
generate a motion vector predictor using the determined other motion vectors stored in the line buffer; and
code the video block based the generated motion vector predictor.

11. The apparatus of claim 10, wherein the determined unavailable control points comprises a top-left or top-right control point and wherein the other motion vectors comprise a bottom-left or a bottom-right motion vector stored in the line buffer.

12. The apparatus of claim 11, wherein each of the bottom-left and the bottom-right motion vectors are corresponding motion vectors of neighboring 4×4 blocks.

13. The apparatus of claim 11, wherein the bottom-left and the bottom-right motion vector are corresponding motion vectors of a bottom-left and a bottom-right control point of the neighboring affine block.

14. The apparatus of claim 13, wherein an affine motion model used to predict the current block comprises a 6-parameter affine motion model, and wherein the control points further comprises a bottom-middle control point.

15. The apparatus of claim 10, wherein an affine motion model used to predict the current block comprises a 4-parameter affine motion model.

16. The apparatus of claim 10, wherein an affine motion model used to predict the current block comprises a 4-parameter affine motion model.

17. The apparatus of claim 10, wherein to code the video block, the processor is configured to encode the video block, comprising the processor being further configured to:
encode data indicating that the video block is encoded based on the generated motion vector predictor;
generate a prediction block based on the generated motion vector predictor;
determine a residual based on the prediction block and the video block; and
encode data indicative of the residual.

18. The apparatus of claim 16, further comprising at least one of:
a camera configured to capture a picture that includes the video block; or
an output interface configured to communicate the encoded video block.

19. The apparatus of claim 10, wherein to code the video block, the processor is configured to decode the video block, comprising the processor being further configured to:
decode data indicating that the video block is encoded based on the generated motion vector predictor;
decode a prediction block based on the generated motion vector predictor;
decode data indicative of a residual for the video block; and
decode the video block using the prediction block and the residual.

20. The apparatus of claim 18, further comprising at least one of:
a display in communication with the processor, the display configured to display a picture that includes the video block; or
an input interface configured to receive the encoded video block.

21. A non-transitory computer-readable medium having stored thereon instructions that when executed cause a processor to:
determine motion vectors for at least three affine control points from neighboring blocks of a current video block, the neighboring blocks comprising a top neighboring block, comprising:
determine for a top neighboring affine block that motion vectors of one or more control points of an affine motion model of the neighboring affine block is unavailable from a line buffer; and
based on the determination that the one or more control points are unavailable, determine one or more other motion vectors based on motion vectors the neighboring blocks that are stored in the line buffer;
generate a motion vector predictor using the determined other motion vectors stored in the line buffer; and
code the video block based the generated motion vector predictor.
